(19) United States
(12) Patent Application Publication
(10) Pub. No.: US 2010/0212167 A1
(43) Pub. Date: Aug. 26, 2010

(54) Plotter having a pen set with ink-supply

(76) Inventor: Zheng-Kuo Lu, Kun Shan City (CN)

Correspondence Address: Muncy, Geissler, Olds & Lowe, PLLC, 4000 Legato Road, Suite 310, FAIRFAX, VA, 22033, US

(21) Appl. No.: 12/003,229

(22) Filed: Dec. 20, 2007

(51) Int. Cl. B43L 13/00; G01D 15/16

(52) U.S. Cl. 33/18.1; 346/140.1

(57) ABSTRACT

A plotter having a pen set with ink-supply is characterized in that: the pen set with ink supply comprises a pen housing, a pen, and an ink-supply container. The pen housing is movably connected to the plotter and is provided with a fixing frame. The pen is detachably connected to the pen housing. The ink-supply container for loading ink is placed in the fixing frame of the pen housing and is in connection with the pen via a connecting tube for supplying ink to the pen.

### BACKGROUND OF THE INVENTION

1. Field of the Invention

The present invention relates to a plotter and, more particularly, to a plotter having a pen set with ink-supply, where the manufacturing cost of the plotter can be reduced, ink can be resupplied to the plotter conveniently, and the residual amount of the ink can be monitored easily.

2. Description of the Prior Art

A conventional plotter comprises a pen housing and a pen. The pen housing is movably connected to a guiding track of the plotter and the pen is detachably connected with the pen housing. The pen can be moved to print a material by moving the pen housing.

Besides, ink is supplied by means of a pneumatic type ink-supply set. The pneumatic type ink-supply set includes an ink-container and a pneumatic type ink-pump. By means of an air cylinder and a pneumatic duct, the pneumatic type ink pump is used to draw out ink from the ink-container into the pen via a connecting tube that is in connection with the pen. Therefore, the conventional plotter has following disadvantages.

First, it is difficult for users to monitor the residual amount of the ink in the ink-container synchronically and consequently fail to resupply ink in time because the ink-container is not connected directly to the pen housing.

Second, the ink has to be supplied to the pen by means of pneumatic ink pump and the use of this extra device will increase the manufacturing cost.

Third, the pneumatic duct has to be arranged in cooperation with the guiding track and consequently the movement of the pen housing on the track will be influenced. Therefore, the operation efficiency of the plotter will be adversely affected.

Forth, when an ink-supply container needs to be replaced, it is a difficult task for general users to replace the old ink-supply container with a new one. If users fail to successively connect the newly replaced ink-supply container with the pneumatic ink pump, the efficiency of ink supply will be reduced and the operation of the plotter will be impaired.

In order to solve these problems mentioned above to provide a plotter having a pen set with ink-supply, by which the manufacturing cost is lowered, the ink thereof can be resupplied conveniently, and the residual amount of the ink thereof can be monitored, inventor had the motive to study and develop the present invention after hard research.

### SUMMARY OF THE INVENTION

An object of the present invention is to provide a plotter having a pen set with ink-supply where an ink-supply container is directly connected to a pen housing of the pen set, and consequently users can operate the plotter and monitor the residual amount of the ink simultaneously.

A further object of the present invention is to provide a plotter having a pen set with ink-supply where the ink-supply container is directly connected to the pen housing of the pen set and ink is directly supplied to a pen, and consequently the manufacturing cost is reduced.

A further object of the present invention is to provide a plotter having a pen set with a simple structure ink-supply and consequently users can replace the original ink-supply container with a new one easily.

Another object of the present invention is to provide a plotter having a pen set with ink-supply, where the ink-supply container is provided with a spring and a piston and consequently ink can be filled into the pen more smoothly.

In order to achieve the above objects, the present invention provides a plotter having a pen set with ink-supply and the pen set of the plotter comprises a pen housing, a pen, and an ink-supply container. The pen housing is movably connected to the plotter and is provided with a fixing frame. The pen is detachably connected to the pen housing. The ink-supply container for loading ink is placed in the fixing frame of the pen housing and is in connection with the pen via a connecting tube for supplying ink to the pen.

Preferably, the ink-supply container is provided with a spring and a piston therein.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is an exploded perspective view showing a plotter having a pen set with ink-supply of the present invention.

FIG. 2 is a perspective view showing the plotter having a pen set with ink-supply of the present invention.

FIG. 3 is a sectional view showing an ink-supply container of the present invention.

### DETAILED DESCRIPTION OF THE PREFERRED EMBODIMENTS

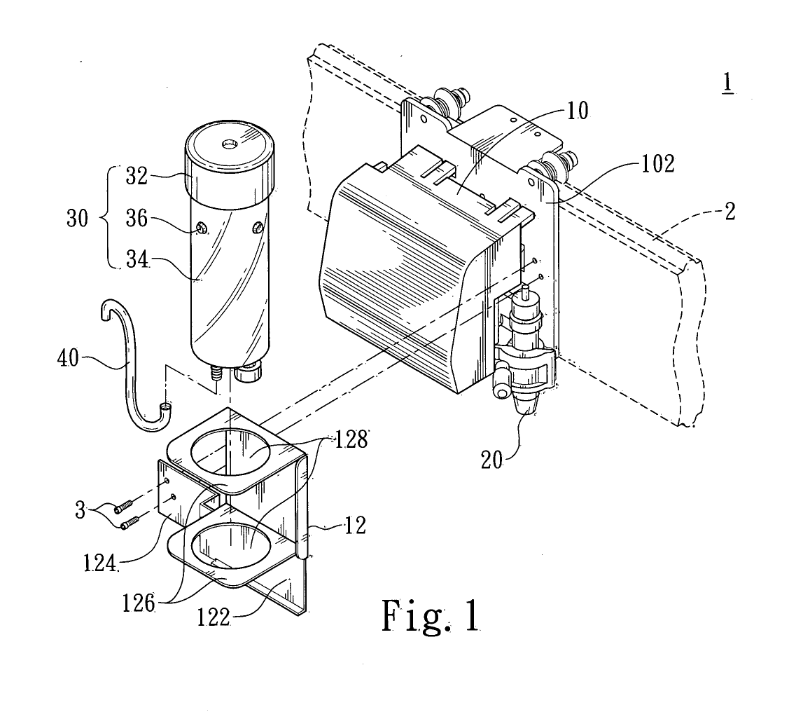

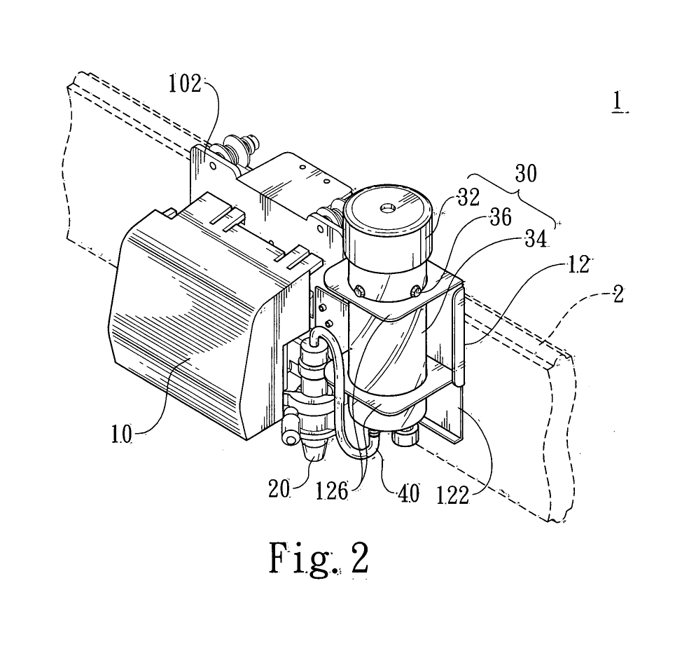

FIGS. 1 and 2 respectively show an exploded perspective view and a perspective view of a plotter having a pen set with ink-supply according to the present invention.

As shown in FIGS. 1 and 2, the plotter having a pen set with ink-supply is characterized in that the pen set with ink supply comprises a pen house 10, a pen 20, and an ink-supply container 30.

The pen housing 10 is movably connected to a guiding track 2 of the plotter and is provided with a fixing frame 12. Users can proceed with a printing procedure by moving the pen housing 10 along the guiding track 2.

The pen 20 is detachably connected to the pen housing 10. The ink-supply container 30 used for loading ink is placed in the fixing frame 12 of the pen housing 10 and is in connection with the pen 20 via a connecting tube 40 for supplying ink to the pen 20.

The fixing frame 12 includes a vertical plate 122 and two horizontal plates 126 that extend from one side of the vertical plate 122 horizontally. Each horizontal plate 126 has a hole 128. The holes 128 of the horizontal plates 126 correspond to each other for locating the ink-supply container 30. The two holes 128 can be of the same size or of different sizes. In this embodiment, the two holes 128 are of the same size.

Besides, the fixing frame 12 has a connecting plate 124 that extends from the vertical plate 122. The connecting plate 124 is connected to a fixing plate 102 of the pen housing 10 for fixing the fixing frame 12 to the pen housing 10. In this embodiment, the connecting plate 124 is fixed to the fixing plate 102 of the pen housing 10 via screws 3.

Moreover, in this embodiment, the ink-supply container 30 is provided with four protruded blocks 36 that are disposed on its external peripheral surface and spaced equidistantly with one another. When the ink-supply container 30 is put into the fixing frame 12, the ink-supply container 30 will be stopped within the fixing frame 12 by means of the four protruded blocks 36.

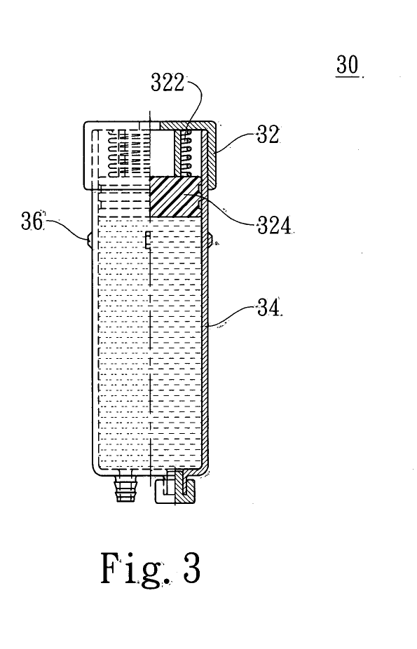

FIG. 3 shows a sectional view of the ink-supply container 30 of the plotter having a pen set with ink-supply according to the present invention. As shown in FIG. 3, the ink-supply container 30 includes a cover 32 and a main body 34 and the cover 32 has a spring 322 and a piston 324 therein. One end of the spring 322 is connected to the inner topside of the cover 32 while the other end of the spring 322 is connected with the piston 324. When the ink-supply container 30 is filled with ink, the piston 324 will be pushed upward and the spring 322 will be compressed consequently. The spring 322 will extend gradually and thus push the piston 324 downwardly while the ink is gradually consumed. Therefore, ink can be supplied to the pen 20 more smoothly.

Thereby, the present invention has following advantages:
1. By disposing the ink-supply container directly to the pen housing of the pen set according to the present invention, users can synchronically monitor the residual amount of the ink while operating the plotter.
2. By disposing the ink-supply container directly to the pen housing of the pen set according to the present invention, the ink can be resupplied to the pen directly and the manufacturing cost can be reduced.
3. It is easy for general users to replace the original ink-supply container with a new one because of the simple structure of the plotter having a pen ser with ink-supply according to the present invention.
4. By disposing the ink-supply container with a spring and a piston according to the present invention, ink can be supplied to the pen more smoothly.

As disclosed in the above description and attached drawings, the present invention can provide a plotter having a pen set with ink-supply, where the plotter is of lower manufacturing cost, the ink thereof can be resupplied conveniently, and the residual amount of the ink thereof can be monitored. It is novel and can be put into industrial use.

It should be understood that different modifications and variations could be made from the disclosures of the present invention by the people familiar in the art, deemed without departing the spirit of the present invention.

What is claimed is:

1. A plotter having a pen set with ink-supply characterized in that: the pen set with ink supply comprises:
a pen housing movably connected to the plotter and provided with a fixing frame;
a pen detachably connected to the pen housing; and
an ink-supply container for loading ink placed in the fixing frame of the pen housing and in connection with the pen via a connecting tube for supplying ink to the pen.

2. The plotter having a pen set with ink-supply as claimed in claim 1, wherein the ink-supply container further includes a cover and a main body; the cover has a spring and a piston therein, and one end of the spring is connected to the inner topside of the cover while the other end of the spring is connected with the piston.

3. The plotter having a pen set with ink-supply as claimed in claim 1, wherein the fixing frame further includes a vertical plate and two horizontal plates extending horizontally from one side of the vertical plate, where the horizontal plates are provided with two corresponding holes respectively for locating the ink-supply container.

4. The plotter having a pen set with ink-supply as claimed in claim 3, wherein the ink-supply container is further provided with at least a protruded block on its external peripheral surface for stopping the ink-supply container in the fixing frame.

5. The plotter having a pen set with ink-supply as claimed in claim 3, wherein the fixing frame is further provided with a connecting plate extending from the vertical plate while the pen housing is further provided with a fixing plate, and the connecting plate is fixed to the fixing plate for fixing the fixing frame to the pen housing.
